(19) United States
(12) Patent Application Publication
(10) Pub. No.: US 2008/0154616 A1
(43) Pub. Date: Jun. 26, 2008

(54) Lottery calculating device

(76) Inventor: Hakam Madi, Sugar Land, TX (US)

Correspondence Address: Hakam Madi, 423 Scarlet Maple DR, Sugarland, TX, 77479, US

(21) Appl. No.: 10/650,577

(22) Filed: Aug. 27, 2003

(51) Int. Cl. G06F 17/40

(52) U.S. Cl. 705/1

(57) ABSTRACT

A device/software for calculating lottery tickets to be used by retailers for the purpose tracking and reporting lottery scratch ticket bundles through computer systems and/or integrated information systems with the main state lottery sale programs thereof.

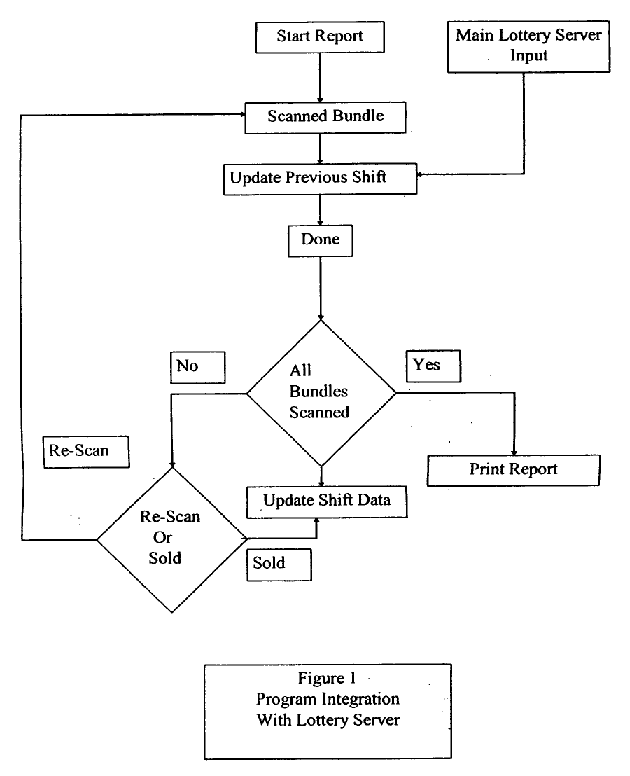

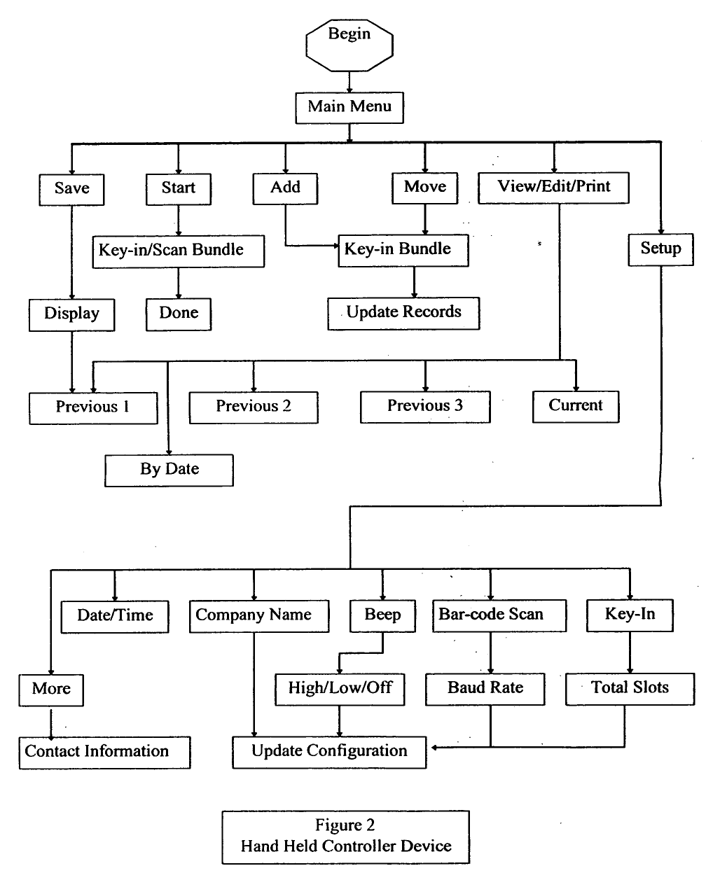

### CROSS-REFERENCE TO RELATED APPLICATION

Not Applicable

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

The present invention relates to a software program which is intended be used by retailers who own computer systems and/or integrated information systems with the main state lottery sale programs.

2. Description of the Prior Art

The use of lottery calculating devices are known in the prior art. More specifically, lottery calculators heretofore devised and utilized are known to consist basically of familiar, expected and obvious structural configurations, notwithstanding the myriad of designs encompassed by the crowded prior art which have been developed for the fulfillment of countless objectives and requirements.

Known prior art lottery calculating devices include U.S. Pat. No. 4,004,372; U.S. Pat. No. 6,405,924; U.S. Pat No. 6,424,703; U.S. Pat No. 6,119,099

While these devices fulfill their respective, particular objectives and requirements, the aforementioned patents do not disclose a software device which will take all the information about that bundle from the main lottery service company or record and track such information. In these respects, the lottery calculating device according to the present invention substantially departs from the conventional concepts and designs of the prior art, and in so doing provides a software apparatus primarily developed for the purpose of minimizing the errors in preparing a total for all sold scratch tickets per shift electronically

### SUMMARY OF THE INVENTION

As of now, the lottery scratch ticket retailers calculate the total sale of the lottery scratch ticket per shift by using different type of hand written reports. This report will require the retailers to keep track of the game number, the value of each ticket in each game and the number of their last ticket sold. Most of the retailers produce this kind of report for each shift. This type of report is time consuming and not error free.

In order for the retailers to control this type of report they avoid adding a new game during one shift without going to the managers first Also moving the games bundle to different locations is limited.

The States Lottery does not have all the information from the retailers about their daily scratch ticket sale. This limitation forces the States Lottery to use an assumption method to charges the retailers for the scratch tickets they sold, and to have a very strict policy toward any lost, stolen or fire damaged scratch tickets.

In using the integrated program of the device, every time the retailer activates a new bundle, the bundle will be registered in and it will take all the information about that bundle from the main lottery service company program. No extra data entry is needed. At the end of the shift the user could enter/scan the last ticket in each bundle and a full report will be printed out. This report will have the time, date, total tickets sold per game, the value of tickets sold per game and the grant total of all tickets sold.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the schematics. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new lottery calculating device apparatus and method which has many of the advantages of the calculating devices mentioned heretofore and many novel features that result in a lottery calculating device which is not anticipated, rendered obvious, suggested, or even implied by any of the prior art tool guides, either alone or in any combination thereof.

It is another object of the present invention to provide a new lottery calculating device which may be easily and efficiently manufactured and marketed.

It is a further object of the present invention to provide a new lottery calculating device which is of a durable and reliable construction.

An even further object of the present invention is to provide a lottery calculating device which is susceptible of a low cost of manufacture with regard to both materials and labor, and which accordingly is then susceptible of low prices of sale to the consuming public, thereby making such lottery calculating device economically available to the buying public.

Still yet another object of the present invention is to provide a new lottery calculating device which provides in the apparatuses and methods of the prior art some of the advantages thereof, while simultaneously overcoming some of the disadvantages normally associated therewith.

Still another object of the present invention is to provide a new lottery calculating device for effecting the calculation of lottery scratch ticket bundles.

Yet another object of the present invention is to provide a new lottery calculating device which includes a hand held device to register the game number, the value per ticket for that game, the size of the bundle and the number of the last ticket sold thereof.

The hand held device would use the same principle of the lottery calculating device program and it will be able to produce the same reports.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying schematics and descriptive matter in which there are illustrated preferred embodiments of the invention.

There will be two modes to enter the data in the hand held device. The two modes are Key-in by using the keypad and Scanning-in by using a bar code scanner/wand. The setup menu configures the data entry mode. The modes are summarized as follows:

A. Key-in Data Entry Mode:

This mode requires that the total number of slots to be configured once.

In this mode the entered bundles are sorted by the slot number, therefore the pointer starts always with the first slot and ends with the last slot number, which was previously assigned by the total slots number.

A.1 Main Menu Options

A.1.1 Start Menu Option

The start menu option will display the slot number; the game number and the sold last ticket number of the previous shift and the cursor will be placed at the new 3-digit ticket number position to be entered. Once the new ticket number is entered, the next slot is displayed. And the process iterates until all slots has been entered. At the end a message stating that all shift games had been finished waiting for the user response to either View the last updates for all slots or to press “Done” that finalizes the new information save process and displaying a summery report.

What is claimed as:

1. A lottery calculating device/software comprising:
Computer software means for which to be used by retailers who own computer systems and/or integrated information systems with the main state lottery sale programs.

2. A lottery calculating device according to claim 1 wherein the software apparatus minimizes the errors in preparing a total for all sold scratch tickets per shift electronically.

3. A lottery calculating device according to claim 1 wherein the device maintains a hand held device to register the game number and the value per ticket for that game, the size of the bundle and the number of the last ticket sold thereof.

4. A lottery calculating device according to claim 1 wherein the device functions are maintained managed and programmed through software.

5. A lottery calculating device according to claim 1 wherein a device calculates lottery scratch tickets.

6. A lottery calculating device according to claim 1 wherein the device will generate a report containing the time, date, total tickets sold per game, the value of tickets sold per game and the grant total of all tickets sold.

7. A lottery calculating device according to claim 1 wherein the software of the device can be accessed on the internet.
